(19) United States
(12) Patent Application Publication
(10) Pub. No.: US 2013/0033033 A1
(43) Pub. Date: Feb. 7, 2013

(54) PIPELINE LINER NON-FLANGE CONNECTION

(71) Applicant: Daniel J. ECK, Anchorage, AK (US)

(72) Inventor: Daniel J. ECK, Anchorage, AK (US)

(73) Assignee: CONOCOPHILLIPS COMPANY, Houston, TX (US)

(21) Appl. No.: 13/559,809

(22) Filed: Jul. 27, 2012

Related U.S. Application Data
(60) Provisional application No. 61/514,761, filed on Aug. 3, 2011.

(51) Int. Cl. F16L 9/14

(52) U.S. Cl. 285/55

(57) ABSTRACT

This invention relates to a non-flange connector capable of fitting around a plastic liner and connecting two sections of pipe without the need for flanges.

### CROSS-REFERENCE TO RELATED APPLICATIONS

This application is a non-provisional application which claims benefit under 35 USC§119(e) of and priority to U.S. Provisional Application Ser. No. 61/514,761 filed 3 Aug. 2011, entitled “PIPELINE LINER NON-FLANGE CONNECTION,” which is incorporated by reference herein in its entirety.

### FIELD OF THE INVENTION

This invention relates to a connector capable of fitting around a plastic internal liner for connecting two sections of pipe without the need for flanges.

### BACKGROUND OF THE INVENTION

Pipelines and other fluid transport systems (such as tubing used down-hole in oil wells and process pipework in oilfields, refineries and the like) can have their life expectancies significantly increased by employing a liner. In many applications a metal, typically a steel, pipeline must be lined with a plastic liner in order to prevent corrosion and/or erosion of the internal surface of the pipe. The liner is incorporated within the pipeline so as to reduce the detrimental effects of corrosion and/or erosion by isolating the bulk fluid from the pipe wall.

Typically, each pipeline will contain ells and flanges. While ells are acceptable in most applications, they may limit the length of liner that can be installed before a flange joint is required to continue the liner installation.

Alternatively, flanges may be welded onto the steel pipe being lined prior to installation of the liner. After the flanges are welded onto the steel pipe, the liner diameter is reduced using rollers and is pulled or pushed into the steel pipe being lined. The end of the liner is then cut and a liner flange is welded onto the liner. The liner is then allowed to shrink, thus positioning the liner flange. This process is repeated at the next pipe section, then the two sections of pipe are bolted together at the flanges. The compression force of the flanges provides the seal between the sections. A ring is used in the flange joints to prevent the liner material from extruding the joint, reducing the compression force, and preventing the liner from leaking.

While flanged joints are acceptable in most applications, advantage could be had in flangeless joints. Such flangeless joints could be constructed to allow for a continuous liner, which may be welded at the joint. Such flangeless joints fluid-proof and vapor-proof the pipeline, eliminate potential leaks, and eliminate fugitive emissions through the joints as standard flanged joints typically have fugitive emissions. Moreover, such flangeless joints would make secondary containment systems perhaps unnecessary.

Therefore, a need exists for a device to allow the connection of sections of pipe lined with a plastic liner without the use standard flanges.

### SUMMARY OF THE INVENTION

In an embodiment of the present invention, a connector includes: (a) a pipe, wherein the pipe is a non-continuous pipe divided into a first pipe section and second pipe section, wherein each pipe section includes a plurality of connection rings welded to the exterior surface of the pipe section, wherein the first pipe section includes a first connection ring, wherein the second pipe section includes a second connection ring, wherein the first and second connection rings align longitudinally; (b) an internal plastic liner disposed within the first pipe section and the second pipe section, wherein the first pipe section is located near one end of the internal plastic liner and the second pipe section is located near the opposite end of the internal plastic liner, wherein a portion of the internal plastic liner between the first pipe section and the second pipe section is exposed; (c) a spacer, wherein the spacer is split longitudinally into a first spacer half and second spacer half, wherein the spacer is disposed around the exposed portion of the internal plastic liner between the first pipe section and the second pipe section, wherein the first spacer half and the second spacer half are joined via a spacer securing mechanism; (d) a circumferential backing strip, wherein the circumferential backing strip prevents the internal plastic liner from extruding gaps between the pipe and the spacer; (e) an axial backing strip, wherein the axial backing strip prevents the internal plastic liner from extruding gaps between the first spacer half and second spacer half; (f) a sleeve, wherein the sleeve is split longitudinally into a first sleeve half and a second sleeve half, wherein the sleeve disposed on top of the spacer between the first pipe section and the second pipe section, wherein the sleeve is secured in place by joining the first sleeve half and the second sleeve half via a sleeve securing mechanism; and (g) at least one connection rod, wherein the connection rod is threaded, wherein one end of the connection rod in inserted into and through the first connection ring welded to the first pipe section and continues until the connection rod reaches the second connection ring welded to the second pipe section, wherein at least two connection nuts secure each end of the rod in place.

In another embodiment of the present invention, a connector includes: (a) a pipe, wherein the pipe is a non-continuous pipe divided into a first pipe section and second pipe section, wherein at least one groove is cut into each section of pipe; (b) an internal plastic liner disposed within the first pipe section and the second pipe section, wherein the first pipe section is located near one end of the internal plastic liner and the second pipe section is located near the opposite end of the internal plastic liner, wherein a portion of the internal plastic liner between the first pipe section and the second pipe section is exposed; (c) a spacer, wherein the spacer is split longitudinally into a first spacer half and second spacer half, wherein the spacer is disposed around the exposed portion of the internal plastic liner between the first pipe section and the second pipe section, wherein the first spacer half and the second spacer half are joined via a spacer securing mechanism; and (d) at least one connection rod, wherein the connection rod is threaded, wherein one end of the connection rod in inserted into and through the first connection ring welded to the first pipe section and continues until the connection rod reaches the second connection ring welded to the second pipe section, wherein at least two connection nuts secure each end of the rod in place.

In yet another embodiment of the present invention, a connector includes: (a) a pipe, wherein the pipe is a non-continuous pipe divided into a first pipe section and second pipe section, wherein a plurality of grooves are cut into each section of pipe; (b) an internal plastic liner disposed within the first pipe section and the second pipe section, wherein the first pipe section is located near one end of the internal plastic liner and the second pipe section is located near the opposite end of the plastic liner, wherein a portion of the internal plastic liner between the first pipe section and the second pipe section is exposed; (c) a spacer, wherein the spacer is split longitudinally into a first spacer half and second spacer half, wherein the spacer is disposed around the exposed portion of the internal plastic liner between the first pipe section and the second pipe section, wherein the first spacer half and the second spacer half are joined via a spacer securing mechanism; (d) a circumferential backing strip, wherein the circumferential backing strip prevents the internal plastic liner from extruding gaps between the pipe and the spacer; (e) an axial backing strip, wherein the axial backing strip prevents the internal plastic liner from extruding gaps between a first spacer half and a second spacer half; (f) a sleeve, wherein the sleeve is split longitudinally into a first sleeve half and a second sleeve half, wherein the sleeve disposed on top of the spacer between the first pipe section and the second pipe section, wherein the sleeve is secured in place by joining the first sleeve half and the second sleeve half via a sleeve securing mechanism; and (g) at least two clamps, wherein one clamp is installed around the first pipe section secured by the groove cut into the first pipe section, wherein one clamp is installed around the second pipe section secured by the groove cut into the second pipe section.

In another embodiment, a connector includes: (a) a pipe, wherein the pipe is a non-continuous pipe divided into a first pipe section and second pipe section, wherein a plurality of grooves are cut into each section of pipe; (b) an internal plastic liner disposed within the first pipe section and the second pipe section, wherein the first pipe section is located near one end of the internal plastic liner and the second pipe section is located near the opposite end of the plastic liner, wherein a portion of the internal plastic liner between the first pipe section and the second pipe section is exposed; (c) a sleeve, wherein the sleeve is split longitudinally into a first sleeve half and a second sleeve half, wherein the sleeve disposed on top of the spacer between the first pipe section and the second pipe section, wherein the sleeve is secured in place by joining the first sleeve half and the second sleeve half via a sleeve securing mechanism; and (d) at least two clamps, wherein one clamp is installed around the first pipe section secured by the groove cut into the first pipe section, wherein one claim is installed around the second pipe section secured by the groove cut into the second pipe section.

### BRIEF DESCRIPTION OF THE DRAWINGS

The invention, together with further advantages thereof, may best be understood by reference to the following description taken in conjunction with the accompanying drawings in which:

FIG. 1 is a depiction of an embodiment of the flangeless connector in accordance with the present invention.

FIG. 2 is a depiction of an embodiment of the flangeless connector in accordance with the present invention.

FIG. 3 is a depiction of an embodiment of the flangeless connector in accordance with the present invention.

### DETAILED DESCRIPTION OF THE INVENTION

Reference will now be made in detail to embodiments of the present invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

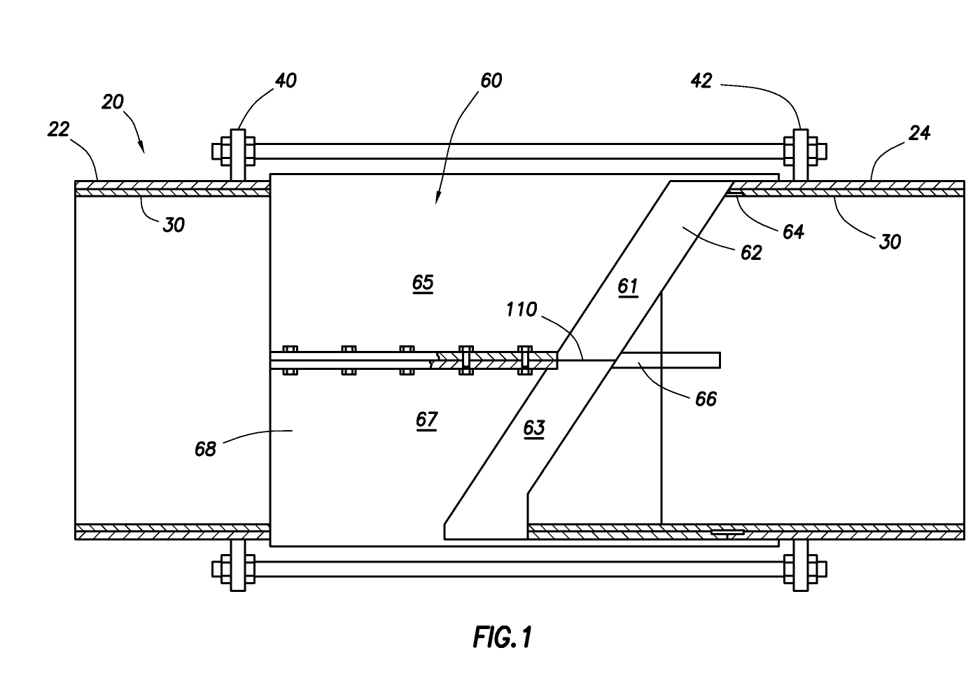

Referring to FIG. 1, a non-continuous pipe 20 divided into a first pipe section 22 and a second pipe section 24 is depicted. A first connection ring 40 is welded to the exterior surface of the first pipe section 22 and a second connection ring 42 is welded to the exterior surface of the second pipe section 24. The first connection ring 40 must longitudinally align with the second connection ring 42. Each pipe section should include at least one connection ring welded to the exterior surface. FIG. 1 depicts two pairs of connection rings welded to the non-continuous pipe 20. Each connection ring includes multiple connection rod holes for insertion of connection rods. The number and placement of connection rod holes should provide the necessary structural and operational integrity. The first and second connection rings should contain the same number of connection rod holes, which must align longitudinally.

An internal plastic liner 30 is installed inside the first pipe section 22 and is either pulled or pushed through to the second pipe section 24 of the non-continuous pipe 20. Thus, the first pipe section 22 is located near one end of the internal plastic liner 30, while the second pipe section 24 is located near the opposite end of the internal plastic liner 30, leaving a portion of the internal plastic liner 30 exposed. The internal plastic liner 30 is welded to each section of the non-continuous pipe to provide a continuous fluid barrier between the interior walls of the non-continuous pipe 20 and the fluid flowing within the piping assembly. In an embodiment, the internal plastic liner is fabricated from high density polyethylene. In yet another embodiment, the internal plastic liner is fabricated from a thermoplastic material, such as nylon, polyester, polypropylene, polytetrafluoroethylene, polyvinylidine fluoride, polyketone, polyethylente, polyamide 11 or combinations thereof.

A connector assembly 60, which includes a spacer 62, a circumferential backing strip 64, an axial backing strip 66 and a sleeve 68, is installed between the first and second pipe sections of the non-continuous pipe 20 around the exposed portion of the internal plastic liner 30. The spacer 62 is split longitudinally into a first spacer half 61 and a second spacer half 63 for placement around the exposed portion of the internal plastic liner 30. The spacer 62 maintains the internal diameter of the non-continuous pipe 20 and prevents the internal plastic liner 30 from expanding by filling the void between the first and second pipe sections on top of the exposed section of the internal plastic liner 30. The spacer may be secured in place via a spacer securing mechanism 110, which brings the first spacer half 61 and the second spacer half 63 back together. In an embodiment, the spacer can be fabricated from a material similar to that of the non-continuous pipe. In an embodiment, the spacer may be eliminated if liner material expansion at the connection is determined not to be an issue.

The circumferential backing strip 64 prevents the internal plastic liner 30 from extruding between the small gaps that may exist between the non-continuous pipe 20 and the spacer 62. In an embodiment, the circumferential backing strips may be eliminated if liner material extrusion is determined to not to be an issue. In an embodiment, a caulk or grout material may be used to prevent the liner from extruding, thus eliminating the need for a circumferential backing strips. The axial backing strip 66 prevents the internal plastic liner 30 from extruding through the small gaps that may exist where the first spacer half 61 and the second spacer half 63 meet.

The sleeve 68, divided into a first sleeve half 65 and a second sleeve half 67, is then placed around the spacer 62, circumferential backing strip 63 and the axial backing strip 66 to provide necessary pressure containment. The sleeve 68 may be secured in place via a sleeve securing mechanism 69, which brings the first sleeve half 65 and the second sleeve half 67 back together. In an embodiment, the securing assembly connects the first and second sleeve halves with bolts.

Upon installation of the connector assembly, at least one connection rod 44 is inserted into and through the first connection ring 40 and continues until the connection rod reaches the second connection ring 42. Thus, one end of the connection rod 44 is located at the first connection ring 40, while the opposite end of the connection rod is located at the second connection ring 42. The connection rod 44 is secured in place. The connection rod 44 serves to prevent axial movement of the non-continuous pipe 2 relative to the connection. In FIG. 1, the connection rod 44 is secured in place via connection nuts 46. In an embodiment, the connection rod is threaded on each end to provide enhanced security.

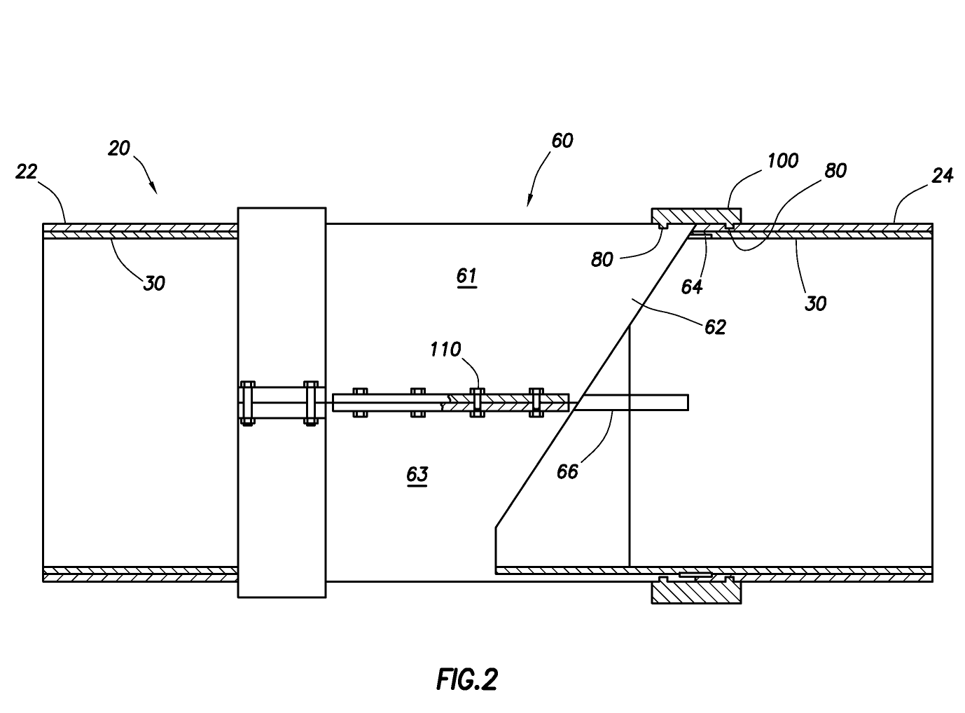

Referring to FIG. 2, which is similar to FIG. 1, a non-continuous pipe 20 divided into a first pipe section 22 and a second pipe section 24 is depicted. At least one groove 80 is cut into each pipe section of the non-continuous pipe 20.

An internal plastic liner 30 is installed inside the first pipe section 22 and is either pulled or pushed through to the second pipe section 24 of the non-continuous pipe 20. Thus, the first pipe section 22 is located near one end of the internal plastic liner 30, while the second pipe section 24 is located near the opposite end of the internal plastic liner 30 leaving a portion of the internal plastic liner 30 exposed. The internal plastic liner 30 is welded to each section of the non-continuous pipe to provide a continuous fluid barrier between the interior walls of the non-continuous pipe 20 and the fluid flowing within the piping assembly. In an embodiment, the internal plastic liner is fabricated from high density polyethylene. In yet another embodiment, the internal plastic liner is fabricated from a thermoplastic material, such as nylon, polyester, polypropylene, polytetrafluoroethylene, polyvinylidine fluoride, polyketone, polyethylente, polyamide 11 or combinations thereof.

A connector assembly 60, which includes a spacer 62, a circumferential backing strip 64, and an axial backing strip 66, is installed between the first and second pipe sections of the non-continuous pipe 20 around the exposed portion of the internal plastic liner 30. The spacer 62 is split longitudinally into a first spacer half 61 and a second spacer half 63 for placement around the exposed portion of the internal plastic liner 30. The spacer 62 maintains the internal diameter of the non-continuous pipe 20 and prevents the internal plastic liner 30 from expanding by filling the void between the first and second pipe sections on top of the exposed section of the internal plastic liner 30. The spacer may be secured in place via a spacer securing mechanism 110, which brings the first spacer half 61 and the second spacer half 63 back together. In an embodiment, the spacer securing mechanism connects the first and second spacer halves with bolts. In an embodiment, the spacer can be fabricated from a material similar to that of the non-continuous pipe. In an embodiment, the spacer may be eliminated if liner material expansion at the connection is determined not to be an issue.

The circumferential backing strip 64 prevents the internal plastic liner 30 from extruding between the small gaps that may exist between the non-continuous pipe 20 and the spacer 62. In an embodiment, the circumferential backing strips may be eliminated if liner material extrusion is determined not to be an issue. In an embodiment, a caulk or grout material may be used to prevent the liner from extruding, thus eliminating the need for a circumferential backing strip. The axial backing strip 66 prevents the internal plastic liner 30 from extruding through the small gaps that may exist where the first spacer half 61 and the second spacer half 63 meet.

A clamp 100 is then installed to secure the connector assembly to the first pipe section 22 and the second pipe section 24 of non-continuous pipe. The clamp 100 along with the spacer 62 provides the pressure containment in conjunction with the sleeve bolts. In this embodiment, grooves are cut into the pipe and into each section of the non-continuous pipe 20 to accept the lugs from the clamp. These lugs and grooves prevent axial movement of the non-continuous pipe 20 relative to the connection. In an embodiment, the clamp is a clam shell clamp. In another embodiment, the clamp is a pipe connector. In yet another embodiment, the clamp is a Victualic® pipe connector.

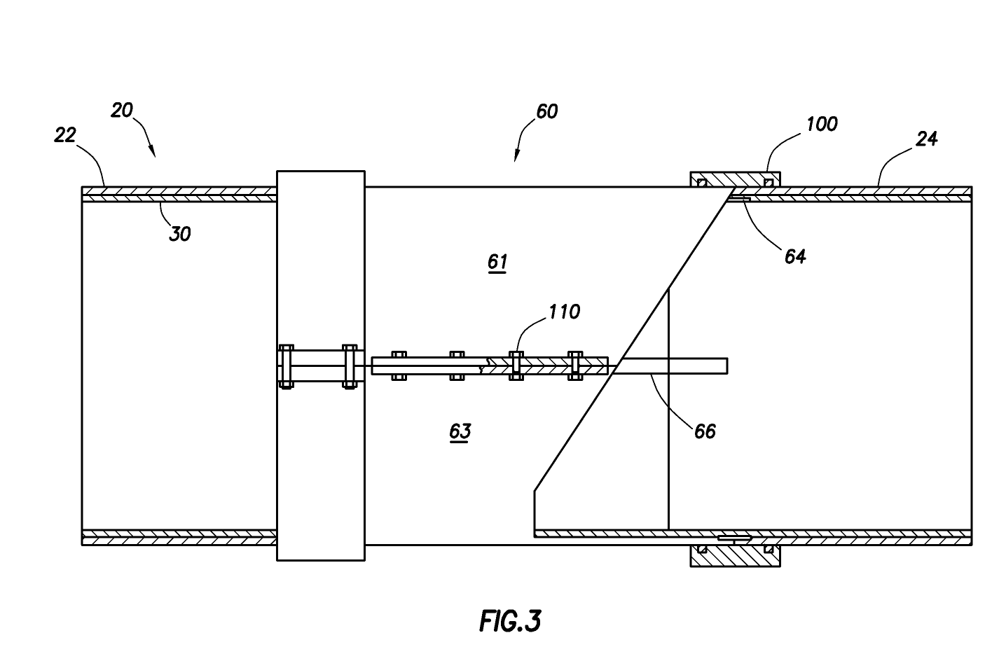

FIG. 3 is similar to FIG. 2, except that FIG. 3 utilizes lug rings to accept and secure the grooves in the clamp. Additionally, the clamp utilized in FIG. 3 is a reverse Victualic® pipe connector.

With the flanged connections there have been instances where the internal plastic liner has shrunk causing the internal plastic liner to tear at the flanged joint allowing the internal fluid to come in contact with the non-continuous pipe and possibly leak out of the flange connection. Because the internal plastic liner is not anchored at the joint, the stress created from any shrinkage of the internal plastic liner is carried through the joint and distributed over a much larger length. Thus, reducing, if not completely eliminating, the risk of the internal plastic liner tearing.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although each apparatus described herein has been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:

1. Lesbsack, D., et al, “Internal Pipeline Rehabilitation Using Polymaide Liner,” Corrosion 97 (1997)

1. A connector, comprising:
a. a pipe, wherein the pipe is a non-continuous pipe divided into a first pipe section and second pipe section, wherein each pipe section includes a plurality of connection rings welded to the exterior surface of the pipe section, wherein the first pipe section includes a first connection ring, wherein the second pipe section includes a second connection ring, wherein the first and second connection rings align longitudinally;
b. an internal plastic liner disposed within the first pipe section and the second pipe section, wherein the first pipe section is located near one end of the internal plastic liner and the second pipe section is located near the opposite end of the internal plastic liner, wherein a portion of the internal plastic liner between the first pipe section and the second pipe section is exposed;
c. a spacer, wherein the spacer is split longitudinally into a first spacer half and second spacer half, wherein the spacer is disposed around the exposed portion of the internal plastic liner between the first pipe section and the second pipe section, wherein the first spacer half and the second spacer half are joined via a spacer securing mechanism;
d. a circumferential backing strip, wherein the circumferential backing strip prevents the internal plastic liner from extruding gaps between the pipe and the spacer;
e. an axial backing strip, wherein the axial backing strip prevents the internal plastic liner from extruding gaps between the first spacer half and second spacer half;
f. a sleeve, wherein the sleeve is split longitudinally into a first sleeve half and a second sleeve half, wherein the sleeve disposed on top of the spacer between the first pipe section and the second pipe section, wherein the sleeve is secured in place by joining the first sleeve half and the second sleeve half via a sleeve securing mechanism; and
g. at least one connection rod, wherein the connection rod is threaded, wherein one end of the connection rod in inserted into and through the first connection ring welded to the first pipe section and continues until the connection rod reaches the second connection ring welded to the second pipe section, wherein at least two connection nuts secure each end of the rod in place.

2. The connector according to claim 1, wherein the internal plastic liner is fabricated from high density polyethylene.

3. The connector according to claim 1, wherein the internal plastic liner is fabricated from a thermoplastic material such as nylon, polyester, polypropylene, polytetrafluoroethylene, polyvinylidine fluoride, polyketone, polyethylente, polyamide 11 or any combinations thereof.

4. The connector according to claim 1, wherein the spacer securing mechanism uses bolts to secure the spacer in place.

5. The connector according to claim 1, wherein the sleeve securing mechanism uses bolts to secure the sleeve in place.

6. A connector, comprising:
a. a pipe, wherein the pipe is a non-continuous pipe divided into a first pipe section and second pipe section, wherein at least one groove is cut into each section of pipe;
b. an internal plastic liner disposed within the first pipe section and the second pipe section, wherein the first pipe section is located near one end of the internal plastic liner and the second pipe section is located near the opposite end of the internal plastic liner, wherein a portion of the internal plastic liner between the first pipe section and the second pipe section is exposed;
c. a spacer, wherein the spacer is split longitudinally into a first spacer half and second spacer half, wherein the spacer is disposed around the exposed portion of the internal plastic liner between the first pipe section and the second pipe section, wherein the first spacer half and the second spacer half are joined via a spacer securing mechanism; and
d. at least one connection rod, wherein the connection rod is threaded, wherein one end of the connection rod in inserted into and through the first connection ring welded to the first pipe section and continues until the connection rod reaches the second connection ring welded to the second pipe section, wherein at least two connection nuts secure each end of the rod in place.

7. The connector according to claim 6, further includes a spacer, wherein the spacer is split longitudinally into a first half and second half, wherein the spacer is disposed around the exposed portion of the internal plastic liner between the first pipe section and the second pipe section.

8. The connector according to claim 6, further includes a circumferential backing strip, wherein the circumferential backing strip prevents the internal plastic liner from extruding gaps between the pipe and the spacer.

9. The connector according to claim 6, further includes an axial backing strip, wherein the axial backing strip prevents the internal plastic liner from extruding gaps between the first half spacer half and second spacer half.

10. The connector according to claim 6, wherein the internal plastic liner is fabricated from high density polyethylene.

11. The connector according to claim 6, wherein the internal plastic liner is fabricated from a thermoplastic material such as nylon, polyester, polypropylene, polytetrafluoroethylene, polyvinylidine fluoride, polyketone, polyethylente, polyamide 11 or any combinations thereof.

12. The connector according to claim 6, wherein the spacer securing mechanism uses bolts to secure the spacer in place.

13. The connector according to claim 6, wherein the sleeve securing mechanism uses bolts to secure the sleeve in place.

14. A connector, comprising:
a. a pipe, wherein the pipe is a non-continuous pipe divided into a first pipe section and second pipe section, wherein a plurality of grooves are cut into each section of pipe;
b. an internal plastic liner disposed within the first pipe section and the second pipe section, wherein the first pipe section is located near one end of the internal plastic liner and the second pipe section is located near the opposite end of the plastic liner, wherein a portion of the internal plastic liner between the first pipe section and the second pipe section is exposed;
c. a spacer, wherein the spacer is split longitudinally into a first spacer half and second spacer half, wherein the spacer is disposed around the exposed portion of the internal plastic liner between the first pipe section and the second pipe section, wherein the first spacer half and the second spacer half are joined via a spacer securing mechanism;
d. a circumferential backing strip, wherein the circumferential backing strip prevents the internal plastic liner from extruding gaps between the pipe and the spacer;
e. an axial backing strip, wherein the axial backing strip prevents the internal plastic liner from extruding gaps between a first spacer half and a second spacer half;
f. a sleeve, wherein the sleeve is split longitudinally into a first sleeve half and a second sleeve half, wherein the sleeve disposed on top of the spacer between the first pipe section and the second pipe section, wherein the sleeve is secured in place by joining the first sleeve half and the second sleeve half via a sleeve securing mechanism; and
g. at least two clamps, wherein one clamp is installed around the first pipe section secured by the groove cut into the first pipe section, wherein one clamp is installed around the second pipe section secured by the groove cut into the second pipe section.

15. The connector according to claim 14, wherein the internal plastic liner is fabricated from high density polyethylene.

16. The connector according to claim 14 wherein the internal plastic liner is fabricated from a thermoplastic material such as nylon, polyester, polypropylene, polytetrafluoroethylene, polyvinylidine fluoride, polyketone, polyethylente, polyamide 11 or any combinations thereof.

17. The connector according to claim 14, wherein the spacer securing mechanism uses bolts to secure the spacer in place.

18. The connector according to claim 6, wherein the sleeve securing mechanism uses bolts to secure the sleeve in place.

19. The connector according to claim 14, wherein the clamp is a clam shell clamp.

20. The connector according to claim 14, wherein the clamps are pipe connectors.

21. The connector according to claim 14, wherein the clamps are Victualic® pipe connectors.

22. The connector according to claim 14, wherein the clamps are reverse Victualic® pipe connectors.

23. A connector, comprising:
a. a pipe, wherein the pipe is a non-continuous pipe divided into a first pipe section and second pipe section, wherein a plurality of grooves are cut into each section of pipe;
b. an internal plastic liner disposed within the first pipe section and the second pipe section, wherein the first pipe section is located near one end of the internal plastic liner and the second pipe section is located near the opposite end of the plastic liner, wherein a portion of the internal plastic liner between the first pipe section and the second pipe section is exposed;
c. a sleeve, wherein the sleeve is split longitudinally into a first sleeve half and a second sleeve half, wherein the sleeve disposed on top of the spacer between the first pipe section and the second pipe section, wherein the sleeve is secured in place by joining the first sleeve half and the second sleeve half via a sleeve securing mechanism; and
d. at least two clamps, wherein one clamp is installed around the first pipe section secured by the groove cut into the first pipe section, wherein one claim is installed around the second pipe section secured by the groove cut into the second pipe section.

24. The connector according to claim 23, further includes a spacer, wherein the spacer is split longitudinally into a first half and second half, wherein the spacer is disposed around the exposed portion of the internal plastic liner between the first pipe section and the second pipe section.

25. The connector according to claim 24, further includes a circumferential backing strip, wherein the circumferential backing strip prevents the internal plastic liner from extruding gaps between the pipe and the spacer.

26. The connector according to claim 24, further includes an axial backing strip, wherein the axial backing strip prevents the internal plastic liner from extruding gaps between the first half and second half of the space.

27. The connector according to claim 23, wherein the internal plastic liner is fabricated from high density polyethylene.

28. The connector according to claim 23, wherein the internal plastic liner is fabricated from a thermoplastic material such as nylon, polyester, polypropylene, polytetrafluoroethylene, polyvinylidine fluoride, polyketone, polyethylente, polyamide 11 or any combinations thereof.

29. The connector according to claim 23, wherein the clamp is a clam shell clamp.

30. The connector according to claim 23, wherein the clamps are pipe connectors.

31. The connector according to claim 23, wherein the clamps are Victualic® pipe connectors.

32. The connector according to claim 23, wherein the clamps are reverse Victualic® pipe connectors.
